(19) United States
(12) Patent Application Publication
(10) Pub. No.: US 2021/0057818 A1
(43) Pub. Date: Feb. 25, 2021

(54) ANTENNAS WITH IN-PHASE IMAGE CURRENT

(71) Applicant: Hewlett-Packard Development Company, L.P., Spring, TX (US)

(72) Inventors: Kai-Cheng Chi, Taipei City (TW); Chen-Ta Hung, Taipei City (TW); Shih-Huang Wu, Spring, TX (US); Isaac Lagnado, Spring, TX (US)

(73) Assignee: Hewlett-Packard Development Company, L.P., Spring, TX (US)

(21) Appl. No.: 16/977,502

(22) PCT Filed: Apr. 25, 2018
(86) PCT No.: PCT/US2018/029323

§ 371 Date: Sep. 2, 2020

(51) Int. Cl. H01Q 5/328; H01Q 1/48; H01Q 1/22; H01Q 13/10

(52) U.S. Cl. CPC H01Q 5/328; H01Q 13/10; H01Q 1/2266; H01Q 1/48

(57) ABSTRACT

Examples of an antenna are described herein. Some examples of the antenna include an antenna holder. In some examples, the antenna holder is situated on a metal cover and a metal surface is situated on a side of the antenna holder to create an in-phase image current on the metal cover.

### BACKGROUND

Electronic devices, such as laptops and cellular phones, include antennas for wireless communication. Such antennas may be mounted in an enclosure or housing of the electronic device. The antennas enable communication of electronic devices with wireless networks and satellite navigation systems.

### BRIEF DESCRIPTION OF THE DRAWINGS

FIG. 1 is a diagram illustrating examples of in-phase image current for an antenna;

FIG. 2 illustrates examples of a coplanar waveguide antenna and a conductor-backed coplanar waveguide (CBCPW) antenna with magnetic currents;

FIG. 3 is a diagram illustrating a top view and a front view of a slot dipole antenna structure with inductive feeding;

FIG. 4 is a diagram illustrating a top view and a front view of a slot dipole antenna structure with inductive feeding including an inductor;

FIG. 5 is a diagram illustrating a top view of a slot dipole antenna structure with a tunable circuit;

FIG. 6 is a diagram illustrating a top view and a front view of a slot dipole antenna structure with capacitive feeding; and

FIG. 7 is a diagram illustrating a top view and a side view of an electronic device with magnetic in-phase image current for an antenna structure.

### DETAILED DESCRIPTION

Electronic devices have an enclosure in which electronic components, such as a processor, a memory, a power source, a cooling fan, an input/output (I/O) port, display, or the like, are housed. Electronic devices may also include a display unit for rendering visual output. The enclosure may be coupled to the display unit through a coupling element, such as a hinge. In an example, the electronic device may be a laptop having a keyboard in the enclosure and a display panel in the display unit.

As the enclosure houses a wide variety of electronic components, the enclosure is space constrained. A wireless antenna is generally mounted within the enclosure along with the other electronic components. While positioning the antenna in the enclosure, certain pre-defined clearances may be maintained between the antenna and other electronic components so that radiations from the antenna do not interfere with functioning of the other components. Positioning the antenna within the enclosure may also result in increased enclosure thickness.

Some electronic devices may have enclosures for achieving a metallic looking form factor. For example, the enclosure may have some portions made of metal. Antennas may be mounted in a gap provided within the metal portion of the enclosure. The gap for the antenna, which may be an antenna window, may be a cut-out in the metal portion. The antenna is placed in the gap and then the gap is covered with a plastic filling member. The radiations from the antenna are transmitted through walls of the plastic filling member. The plastic filling member is then coated with metal-finish paints in order to give the plastic filling member an appearance similar to the surrounding metal portion of the enclosure. Cutting a gap in the metal portion, positioning the antenna in the gap, covering the gap with the plastic filling member, and coating the plastic filling member with metal-finish paints involves additional material cost of the plastic filling member and the metal-finish paints and also involves additional production steps and production time.

Some examples of the antennas described herein may be implemented in a windowless enclosure (e.g., windowless metal case). Some examples may avoid the extra plastic window area and painting decorations. Additionally or alternatively, some examples may avoid extra base thickness. For instance, some electronic devices (e.g., laptops, tablets, smartphones, etc.) may be manufactured with all-metal enclosures or covers for durability and/or aesthetics. All-metal enclosures or covers (e.g., windowless enclosures or covers) may impact antenna performance. In particular, antenna performance for some antenna types (e.g., monopoles, planar inverted-F antennas (PIFAs), loops, etc.) may be degraded due to a strong energy coupling between antenna and metal cover.

Antenna performance may be improved by means of image current theory. Some examples of the antennas described herein may control electrical current and/or virtual magnetic current direction in order to create an in-phase image current on the metal cover to enhance antenna performance. For example, in a slot dipole antenna fed by conductor-backed coplanar waveguide (CBCPW), an electric field vector Ē may proceed across at least a portion of one or more slots. An equivalent virtual current vector may be expressed as M̅=Ē×N̅, where N̅ is a normal vector and × denotes a vector cross calculation. The equivalent virtual current vector may proceed along (e.g., within) at least a portion of one or more slots. Some examples of antennas include a lump capacitor to reduce antenna size. Reduced antenna size may be beneficial in some implementations (e.g., low-profile designs).

It should be noted that a slot dipole antenna may be fed by CBCPW inductively or CBCPW capacitively. Regardless of the feeding type, the slot dipole may generate magnetic current. Therefore, in-phase magnetic current may be generated in accordance with image current theory.

Examples of antennas include coplanar waveguide antennas. A coplanar waveguide antenna includes one or more ground surfaces that are coplanar with a metal surface to feed the antenna signal. For example, antenna signal feed may be coupled to the metal surface. As used herein, the term “coplanar” may include implementations that are approximately coplanar. For example, in order to integrate a coplanar waveguide into a device (e.g., electronic device, system, etc.), parameters for the width of signal feeding and the gap between signal and ground may be specified. The ground surface(s) may be laterally separated from the metal surface by one or more slots or slits. For example, a ground surface may be laterally separated from the metal surface by 0.5 mm to 1.0 mm or more. In some examples, the metal surface (e.g., plate, excitation surface, radiator, etc.) may be shorted to ground. For instance, a ground wall or metal ground plate may short the metal surface to ground. For coplanar waveguide antennas, one or more resonance bands may occur based on the geometry of the metal surface and/or the ground surface(s). For example, the geometry may be implemented to provide one or more resonances for the frequency bands of interest (e.g., 2.4 gigahertz (GHz) and 5 GHz for wireless local area network (WLAN) applications).

Examples of coplanar waveguide antennas include CBCPW antennas. In CBCPW antennas, the metal surface to feed the antenna signal is situated parallel to a conductor. Examples of conductors include metal covers, metal plates, metal planes, etc. As used herein, the term “parallel” may include implementations that are approximately parallel.

In some examples, the metal surface may be separated from the conductor by an antenna holder. The antenna holder may be implemented with a variety of materials. In an implementation, the antenna holder has walls formed from a plastic material, such as Polycarbonate/Acrylonitrile Butadiene Styrene (PC/ABS). The antenna holder may be hollow or may contain a di-electric material within the plastic walls. In an example implementation, the di-electric material contained within the walls of the plastic antenna holder may have a di-electric constant higher than plastic. In an example implementation, a ceramic material may be contained within the walls of the plastic antenna holder, where ceramic has a di-electric constant higher than plastic. In some examples (for wireless local area network (WLAN) applications, for instance), the keep-out area dimensions (the length, width, and height of the antenna space in mm³) may have a length ‘L’ in a range of about 45 mm to about 55 mm, a width ‘W’ in a range of about 8 mm to about 12 mm, and a height ‘H’ in a range of about 3.0 mm to about 5 mm. The dimensions may be determined to meet an antenna specification. The dimensions may fit into a variety of electronic devices, such as clamshell laptops, hybrid laptop/tablet devices, tablet devices, televisions, computers, vehicles, etc.

Some examples of the antennas described herein include multi-band slot dipole (e.g., CBCPW fed) antennas. Some examples of the antennas described herein may be reduced in size by implementing one or more lump capacitors. Antenna resonant frequencies may be adjusted by implementing one or more inductors and/or capacitors. Additionally or alternatively, one or more tuning circuits (e.g., tuning matching circuits) may be implemented to enable adjustment of one or more antenna resonant frequencies (e.g., frequencies for WLAN (e.g., Wi-Fi), cellular (e.g., Long Term Evolution (LTE)), Global Positioning System (GPS), and/or Bluetooth, etc.).

The following detailed description refers to the accompanying drawings. The same or similar reference numbers may be used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

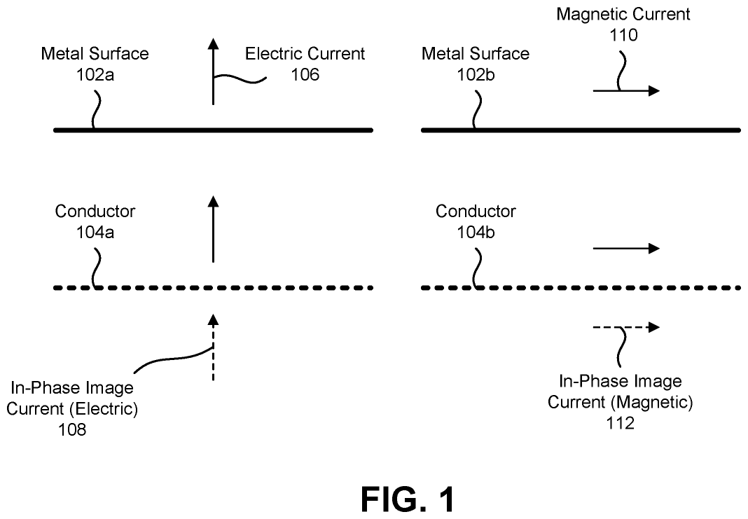

FIG. 1 is a diagram illustrating examples of in-phase image current for an antenna. In particular, FIG. 1 illustrates metal surfaces 102a-b. The metal surfaces 102a-b are examples of metal surfaces of an antenna. For instance, the metal surfaces 102a-b are examples of a radiation mechanism of an antenna.

As illustrated in FIG. 1, an electric current 106 may be applied to a first metal surface 102a. A first conductor 104a is situated parallel to the first metal surface 102a. In some examples, the first conductor 104a is a metal cover (of an electronic device, for instance) or a metal plane. It should be noted that the term “plane” may include approximate planarity. For example, a metal plane may vary from an exact plane.

In an arrangement where a current is applied to metal that is situated nearby a conductor, the resulting electromagnetic field induces a current in the nearby conductor. The current in the conductor is referred to as an image current. Image current may be expressed in terms of electric image current and/or magnetic image current. In general, image current in the conductor may oppose the direction of the current flow in the metal. In particular, the image current in the conductor may be out-of-phase with the current flow of the metal. Accordingly, when the metal surface of an antenna is situated near a conductor (e.g., a metal cover), antenna performance may be reduced because of the strong energy coupling between the metal surface and the conductor. Examples of antennas described herein may improve antenna performance by creating an in-phase image current in a conductor. For instance, in-phase image currents may provide better performance for antennas situated against metal covers.

As illustrated in FIG. 1, in-phase image current may be created on and/or in a conductor to improve antenna performance. For example, an electric in-phase image current 108 may be produced on the first conductor 104a. In particular, the electric in-phase image current 108 on the first conductor 104a may be in-phase with the electric current 106 of the first metal surface 102a. For example, the electric in-phase image current 108 may be flowing in the same direction as the electric current 106 in the first metal surface 102a.

In another example, a magnetic in-phase image current 112 may be produced on a second conductor 104b. In particular, the magnetic in-phase image current 112 on the second conductor 104b may be in-phase with the magnetic current 110 of the second metal surface 102b. For example, the magnetic in-phase image current 112 may be flowing in the same direction as the magnetic current 110 in the second metal surface 102b.

It should be noted that image current theory may be utilized in antenna design. For example, it may be assumed that an antenna will be placed on a large metal conductor (e.g., conductors 104a-b). Analysis may be simplified by assuming that the large conductor is removed and by adding an artificial current for physical consistency.

Some antennas may radiate due to accelerating electric charge, which can generate electrical current. Complementary to electrical current is magnetic current, which may be expressed using mathematical equivalence from electrical current. Electrical types of antennas may generate radiated signals using electrical current. For some electrical antennas, the corresponding image current may be out of phase according to image current theory. Magnetic types of antennas may generate an equivalent image current that is in phase (e.g., in-phase image current 112).

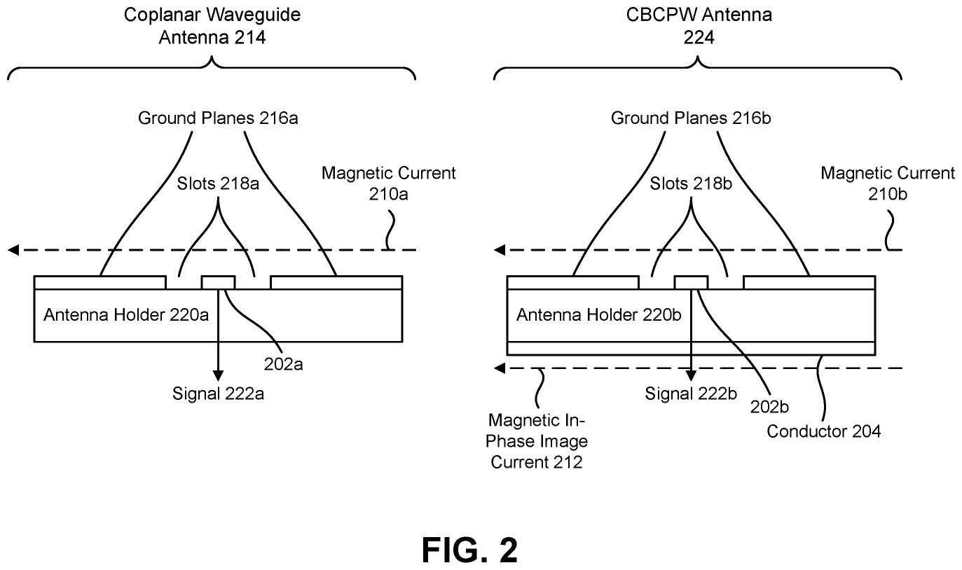

FIG. 2 illustrates examples of a coplanar waveguide antenna 214 and a conductor-backed coplanar waveguide (CBCPW) antenna 224 with magnetic currents 210a-b. As illustrated in FIG. 2, the coplanar waveguide antenna 214 includes a first metal surface 202a, first ground planes 216a, first slots 218a (e.g., gaps, slits, etc.), and a first antenna holder 220a. Examples of The first metal surface 202a and first ground planes 216a may be implemented with copper surfaces. Examples of the first antenna holder 220a may be implemented with a substrate (e.g., dielectric substrate). In some implementations, the first antenna holder 220a may be parallelepipedal and/or cuboid in shape. As illustrated in FIG. 2, the coplanar waveguide antenna 214 may radiate a first signal 222a. A first magnetic current 210a (e.g., horizontal magnetic current, transverse magnetic current, etc.) may be created. When situated on or nearby a conductor, the first magnetic current 210a may have a corresponding magnetic in-phase image current on and/or in the conductor.

As illustrated in FIG. 2, the CBCPW antenna 224 includes a second metal surface 202b, second ground planes 216b, second slots 218b (e.g., gaps, slits, etc.), and a second antenna holder 220b. Examples of The second metal surface 202b and second ground planes 216b may be implemented with copper surfaces. Examples of the second antenna holder 220b may be implemented with a substrate (e.g., dielectric substrate). In some implementations, the second antenna holder 220b may be parallelepipedal and/or cuboid in shape. The second antenna holder 220b is situated on a conductor 204 (e.g., metal cover, metal plane, metal enclosure, etc.). As illustrated in FIG. 2, the CBCPW antenna 224 may radiate a second signal 222b through the conductor 204. A second magnetic current 210b (e.g., horizontal magnetic current, transverse magnetic current, etc.) may be created. The second magnetic current 210b may have a corresponding magnetic in-phase image current 212 on and/or in the conductor.

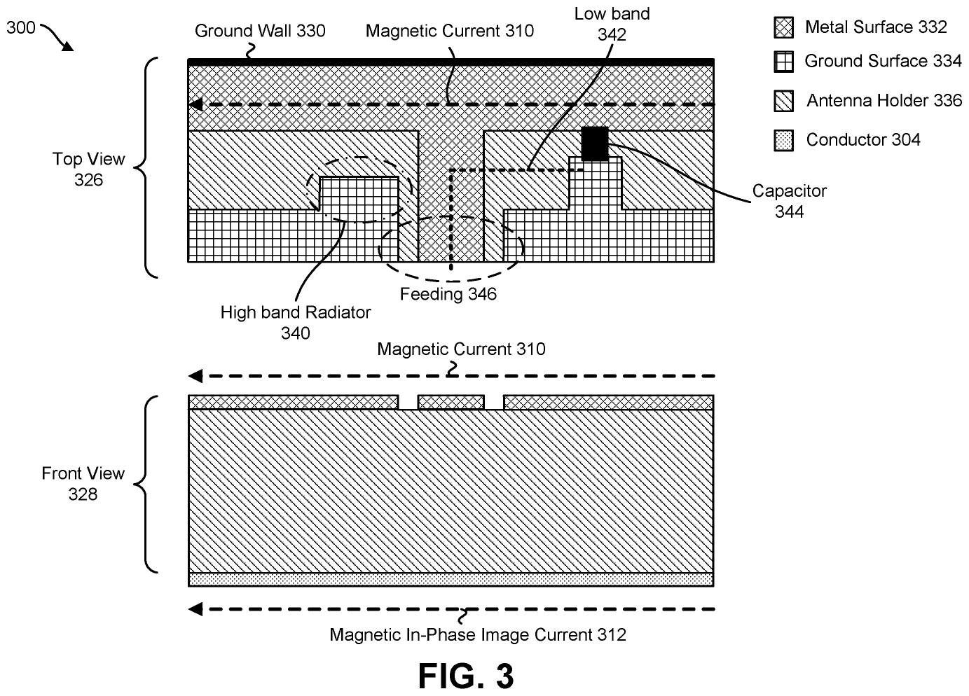

FIG. 3 is a diagram illustrating a top view 326 and a front view 328 of a slot dipole antenna structure 300 with inductive feeding. The slot dipole antenna structure 300 may be an example of a waveguide antenna and includes a metal surface 332, ground surfaces 334, a ground wall 330, and an antenna holder 336. The antenna holder 336 may be situated on a conductor 304 (e.g., metal cover, metal plane, etc.).

In some examples, the antenna holder 336 has a parallelepipedal structure. In particular, the parallelepipedal structure may include six sides, twelve edges, and eight vertices (e.g., corners at the intersection of three sides). When referring to antenna holders herein, the sides may be referred to as a first side, a second side (where the second side is opposite from the first side), a third side (where the third side is between the first side and the second side), a fourth side (where the fourth side is opposite from the third side), a fifth side, and a sixth side (where the sixth side is opposite from the fifth side). For convenience, the first side may be visualized as a top side, the second side may be visualized as a bottom side, the third side may be visualized as a back side, the fourth side may be visualized as a front side, the fifth side may be visualized as a right side, and the sixth side may be visualized as a left side. The metal surface 332 (e.g., plate) may be situated on the first side of the antenna holder 336. The ground wall 330 (e.g., metal ground plate, grounded plate) may be situated on the third side of the antenna holder 336. In the example illustrated in FIG. 3, feeding 346 (e.g., CBCPW feeding) may be performed from the front of the slot dipole antenna structure 300. For instance, a source feed may be coupled to the metal surface 332. FIG. 3 may provide an example of a slot dipole fed by CBCPW.

A magnetic current 310 may be created (e.g., produced) to have a magnetic in-phase image current 312 on and/or in the conductor 304. The magnetic current 310 may be horizontal or transverse magnetic current. For example, the horizontal magnetic current 310 may flow in a direction along the ground wall 330. For instance, a transverse magnetic current may flow parallel to a metal ground plate or grounded plate (e.g., the ground wall 330). As illustrated in FIG. 3, some examples of the antennas described herein include slot dipole antennas with CBCPW feeding. A slot antenna may be categorized as a magnetic type antenna. Accordingly, a slot dipole antenna may generate equivalent magnetic current. In some examples, a slot dipole antenna may be placed on a relatively large conductor. After accounting for image current theory, there may be an in-phase magnetic current, which may improve antenna radiation.

In the example illustrated in FIG. 3, a first ground surface 334 situated on the first side is separated from the metal surface 332 by a first slot. A low band resonance is produced with a path 342 for a low band (from the metal surface 332 to the first ground surface 334). In this example, a capacitor 344 is coupled between the first ground surface 334 and the metal surface 332 (next to the magnetic current 310, for example). Implementing the capacitor 344 (e.g., lump capacitor) may enable a reduced antenna size. A second ground surface 334 situated on the first side is separated from the metal surface 332 by a second slot and includes a high-band radiator 340. In particular, a high band resonance is produced from a parasitic radiator in one of the ground surfaces 334. The antenna geometry may be structured to provide high band and low band resonances for particular bands of interest. It should be noted that variations of the antenna structure 300 may be implemented. For example, an antenna with one or more slots and/or ground surfaces may be implemented.

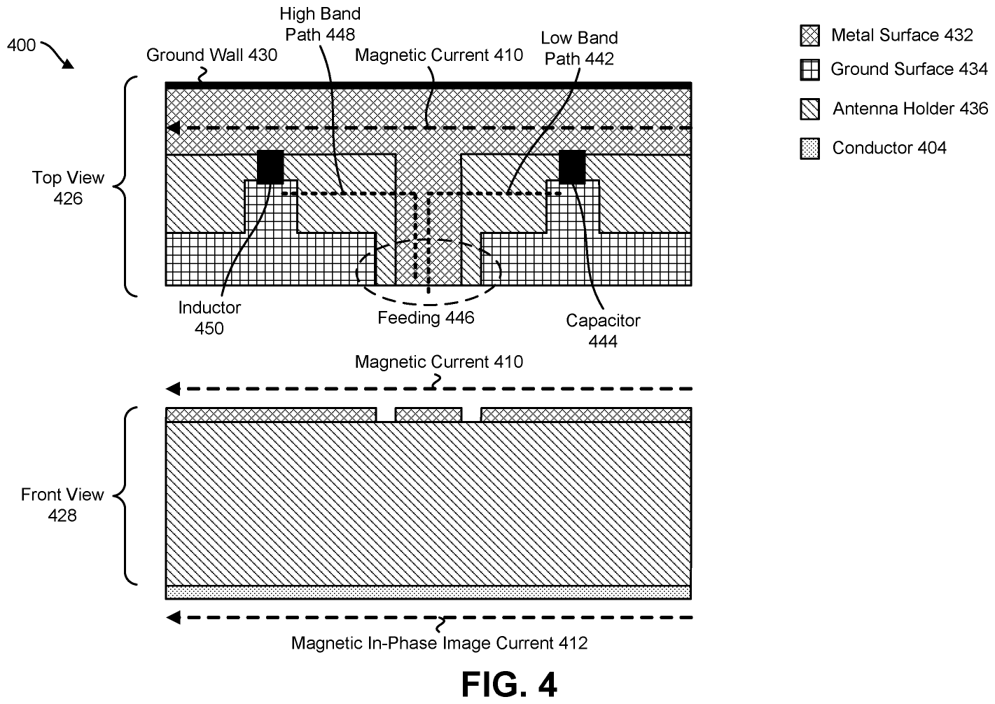

FIG. 4 is a diagram illustrating a top view 426 and a front view 428 of a slot dipole antenna structure 400 with inductive feeding including an inductor 450. The slot dipole antenna structure 400 may be an example of a waveguide antenna and includes a metal surface 432, ground surfaces 434, a ground wall 430, and an antenna holder 436. The antenna holder 436 may be situated on a conductor 404 (e.g., metal cover, metal plane, etc.). The metal surface 432 (e.g., plate) may be situated on the first side of the antenna holder 436. The ground wall 430 may be situated on the third side of the antenna holder 436. In the example illustrated in FIG. 4, feeding 446 (e.g., CBCPW feeding) may be performed from the front of the slot dipole antenna structure 400. For instance, a source feed may be coupled to the metal surface 432. FIG. 3 may provide an example of a slot dipole fed by CBCPW.

A magnetic current 410 may be created (e.g., produced) to have a magnetic in-phase image current 412 on and/or in the conductor 404. The magnetic current 410 may be horizontal or transverse magnetic current. For example, the horizontal magnetic current 410 may flow in a direction along the ground wall 430. For instance, a transverse magnetic current may flow parallel to a metal ground plate or grounded plate (e.g., the ground wall 430).

In the example illustrated in FIG. 4, a first ground surface 434 situated on the first side is separated from the metal surface 432 by a first slot. A low band resonance is produced with a path 442 for a low band (from the metal surface 432 to the first ground surface 434). In this example, a capacitor 444 is coupled between the first ground surface 434 and the metal surface 432. As described above, implementing the capacitor 444 (e.g., lump capacitor) may enable a reduced antenna size. A second ground surface 434 situated on the first side is separated from the metal surface 432 by a second slot. A high band resonance is produced with a path 448 for a high band (from the metal surface 432 to the second ground surface 434). In this example, an inductor 450 is coupled between the second ground surface 434 and the metal surface 432 (next to the magnetic current 410, for example). The inductor 450 may be implemented to shift a resonant frequency for a frequency of interest (e.g., 5 GHz). The antenna geometry may be structured to provide high band and low band resonances for particular bands of interest. It should be noted that variations of the antenna structure 400 may be implemented. For example, an antenna with one or more slots and/or ground surfaces may be implemented.

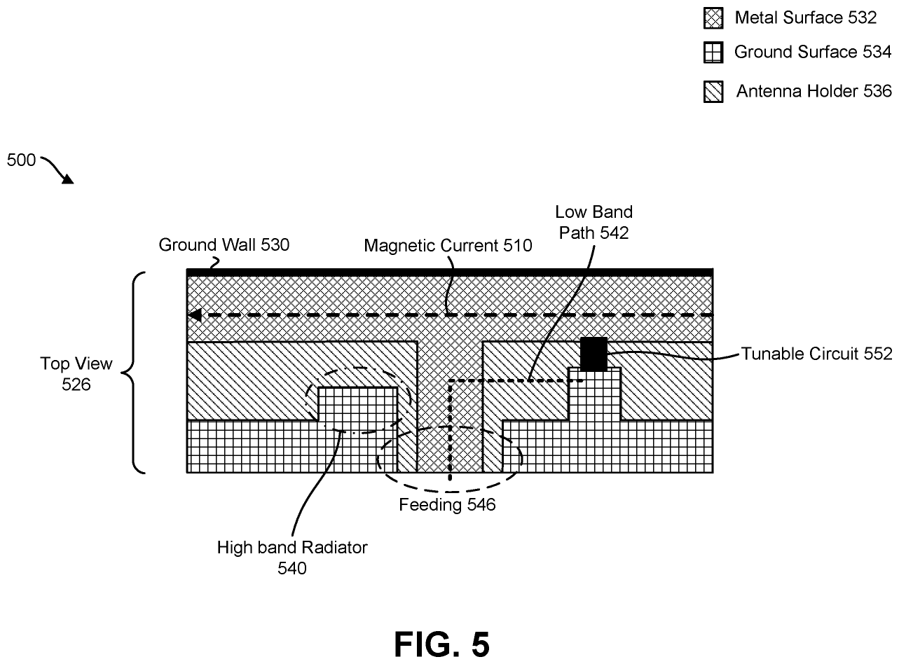

FIG. 5 is a diagram illustrating a top view 526 of a slot dipole antenna structure 500 with a tunable circuit 552. The slot dipole antenna structure 500 may be an example of a waveguide antenna and includes a metal surface 532, ground surfaces 534, a ground wall 530, and an antenna holder 536. The antenna holder 536 may be situated on a conductor (e.g., metal cover, metal plane, etc.). The metal surface 532 (e.g., plate) may be situated on the first side of the antenna holder 536. The ground wall 530 (e.g., metal ground plate, grounded plate) may be situated on the third side of the antenna holder 536. In the example illustrated in FIG. 5, feeding 546 (e.g., CBCPW feeding) may be performed from the front of the slot dipole antenna structure 500. For instance, a source feed may be coupled to the metal surface 532. FIG. 5 may provide an example of a slot dipole fed by CBCPW.

A magnetic current 510 may be created (e.g., produced) to have a magnetic in-phase image current. As described above, the magnetic current 510 may be horizontal or transverse magnetic current.

In the example illustrated in FIG. 5, a first ground surface 534 situated on the first side is separated from the metal surface 532 by a first slot. A low band resonance is produced with a path 542 for a low band (from the metal surface 532 to the first ground surface 534). In this example, a tunable circuit 552 is coupled between the first ground surface 534 and the metal surface 532 (next to the magnetic current 510, for example). The tunable circuit 552 may enable tuning antenna resonance for multiple bands (e.g., provide a selection of antenna states). For example, the tunable circuit 552 may provide tunable capacitance and/or inductance to change at least one resonant frequency band. In some examples, the tunable circuit 552 may have multiple states corresponding to frequency bands. For instance, the tunable circuit 552 may provide a selection of four states: a first state for a 2.4 GHz resonance (e.g., WLAN), a second state for a 1.5 GHz resonance (e.g., Global Positioning System (GPS)), a third state for a resonance in a range of approximately 1710 megahertz (MHz) to 1850 MHz (e.g., Long Term Evolution (LTE) Band 3), and a fourth state for a resonance of approximately 1920 MHz to 2170 MHz (e.g., LTE Band 1).

A second ground surface 534 situated on the first side is separated from the metal surface 532 by a second slot and includes a high-band radiator 540. In particular, a high band resonance is produced from a parasitic radiator in one of the ground surfaces 534. The antenna geometry may be structured to provide high band and low band resonances for particular bands of interest. It should be noted that variations of the antenna structure 500 may be implemented.

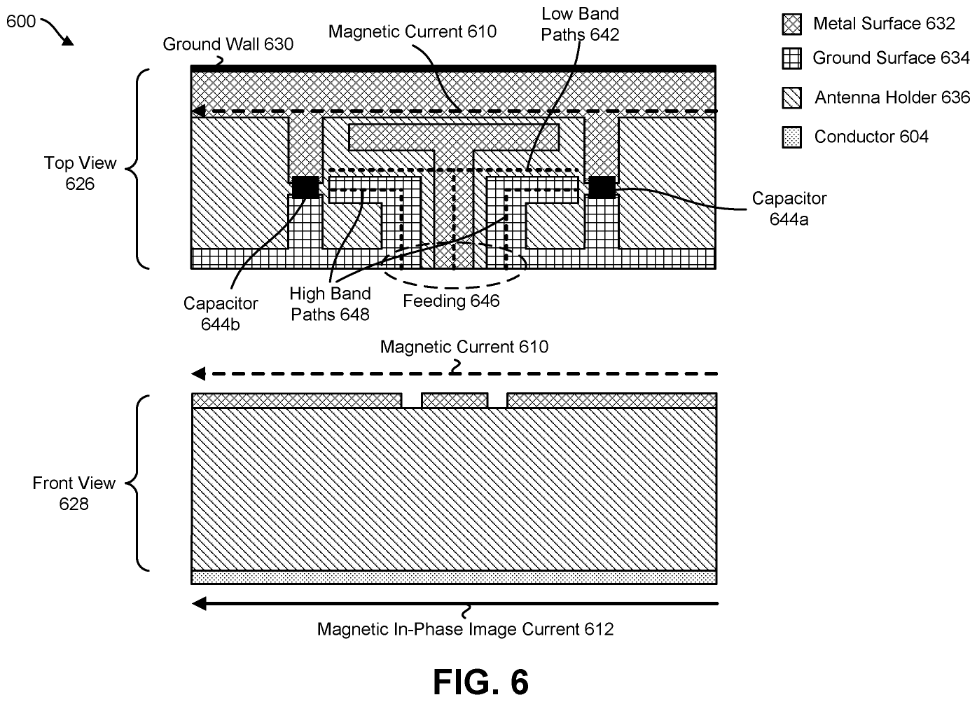

FIG. 6 is a diagram illustrating a top view 626 and a front view 628 of a slot dipole antenna structure 600 with capacitive feeding. The slot dipole antenna structure 600 may be an example of a waveguide antenna and includes metal surfaces 632, ground surfaces 634, a ground wall 630, and an antenna holder 636. The antenna holder 636 may be situated on a conductor 604 (e.g., metal cover, metal plane, etc.). The metal surface 632 (e.g., plate) may be situated on the first side of the antenna holder 636. The ground wall 630 (e.g., metal ground plate, grounded plate) may be situated on the third side of the antenna holder 636. In the example illustrated in FIG. 6, feeding 646 (e.g., CBCPW feeding) may be performed from the front of the slot dipole antenna structure 600. For instance, a source feed may be coupled to a metal surface 632. FIG. 3 may provide an example of a slot dipole fed by CBCPW.

Capacitive feeding may offer some advantages. Compared with inductive feeding, for example, the input impedance of capacitive feeding may be smaller. Accordingly, the antenna structure 600 may be easier to match with other circuitry (e.g., feeding circuitry, communication circuitry, etc.). Energy loss may also be reduced.

A magnetic current 610 may be created (e.g., produced) to have a magnetic in-phase image current 612 on and/or in the conductor 604. The magnetic current 610 may be horizontal or transverse magnetic current. For example, the horizontal magnetic current 610 may flow in a direction along the ground wall 630. For instance, a transverse magnetic current may flow parallel to a metal ground plate or grounded plate (e.g., the ground wall 630).

In the example illustrated in FIG. 6, a first ground surface 634 situated on the first side is separated from a metal surface 632 by a first slot. A second ground surface 634 situated on the first side is separated from the metal surface 632 by a second slot. A low band resonance is produced with symmetric paths 642 for a low band (between the metal surfaces 632). In this example, (next to the magnetic current 610, for instance) a first capacitor 644a is coupled between the first ground surface 634 and a metal surface 632 (that is by the ground wall 630), and a second capacitor 644b is coupled between the second ground surface 634 and the metal surface 632 (that is by the ground wall 630). As described above, implementing the capacitors 644a-b (e.g., lump capacitors) may enable a reduced antenna size. A high band resonance is produced with paths 648 for a high band. In this example, the high band resonance created by two parasitic strips along the symmetric high band paths 648. It should be noted that variations of the antenna structure 600 may be implemented. For example, an antenna with one or more slots and/or ground surfaces may be implemented.

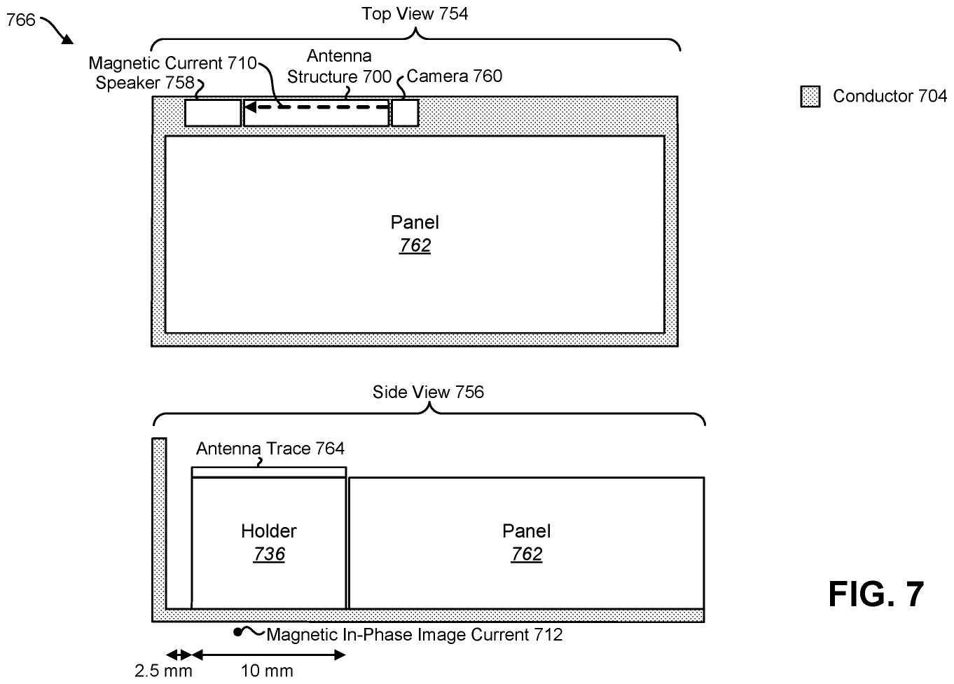

FIG. 7 is a diagram illustrating a top view 754 and a side view 756 of an electronic device 766 with magnetic in-phase image current 712 for an antenna structure 700. Examples of the electronic device 766 include tablet devices, hybrid devices (e.g., laptop/tablet), monitors, smart phones, televisions, computers, etc. The electronic device 766 may include various components (e.g., devices) such as a speaker 758, antenna structure 700, camera 760, and/or a panel 762. The antenna structure 700 may be an example of one or more of the antenna structures described herein.

As illustrated in FIG. 7, the antenna structure 700 includes an antenna holder 736 and an antenna trace 764. In this example, the antenna holder 736 has dimensions of 50 mm×10 mm×4.5 mm. The antenna trace 764 may include one or more metal surfaces and/or ground surfaces. The electronic device 766 may be constructed of a conductor 704 (e.g., metal cover, metal frame, one or more metal planes, etc.). The antenna structure 700 (e.g., the second side of the antenna holder 736) may be situated on (e.g., covered by, enclosed by, etc.) the conductor 704. Another side of the antenna holder 736 may be spaced from the conductor (e.g., a side may be spaced by 2.5 mm as illustrated). A magnetic current 710 may be created in the antenna structure 700 (e.g., the antenna trace 764), and a magnetic in-phase image current 712 may also be created. The magnetic in-phase image current 712 may flow in the same direction (e.g., in parallel with) the magnetic current. As described herein, the magnetic in-phase image current 712 may improve antenna performance (e.g., radiation).

It should be noted that variations of the electronic device 766 may be implemented. For example, the antenna structure 700 may be arranged at different locations (e.g., along different bezels, under a panel, etc.) within an electronic device.

1. An antenna, comprising:
an antenna holder, wherein a second side of the antenna holder is situated on a metal cover; and
a metal surface situated on a first side of the antenna holder to create an in-phase image current on the metal cover.

2. The antenna of claim 1, wherein a horizontal magnetic current of the metal surface is created to have the in-phase image current on the metal cover.

3. The antenna of claim 2, wherein the horizontal magnetic current flows in a direction along a ground wall situated on a third side of the antenna holder between the first side and the second side.

4. The antenna of claim 2, further comprising:
a first ground surface situated on the first side and separated from the metal surface by a first slot to produce a first band resonance; and
a capacitor coupled between the first ground surface and the metal surface next to the horizontal magnetic current.

5. The antenna of claim 4, further comprising:
a second ground surface situated on the first side and separated from the metal surface by a second slot to produce a second band resonance; and
an inductor coupled between the second ground surface and the metal surface next to the horizontal magnetic current.

6. The antenna of claim 2, further comprising:
a first ground surface situated on the first side and separated from the metal surface by a first slot; and
a tunable circuit coupled between the first ground surface and the metal surface next to the horizontal magnetic current to provide a selection of antenna states.

7. The antenna of claim 2, further comprising:
a first ground surface situated on the first side and separated from the metal surface by a first slot;
a first capacitor coupled between the first ground surface and the metal surface next to the horizontal magnetic current;
a second ground surface situated on the first side and separated from the metal surface by a second slot; and
a second capacitor coupled between the second ground surface and the metal surface next to the horizontal magnetic current.

8. A waveguide antenna, comprising:
a substrate positioned on a metal plane;
a metal plate positioned on the substrate, wherein the metal plate is positioned parallel to the metal plane to produce a transverse magnetic current on the metal plate with an in-phase image current on the metal plane.

9. The waveguide antenna of claim 8, wherein the waveguide antenna is fed by conductor-backed coplanar waveguide inductively.

10. The waveguide antenna of claim 8, wherein the waveguide antenna is fed by conductor-backed coplanar waveguide capacitively.

11. The waveguide antenna of claim 8, wherein the transverse magnetic current flows parallel to a ground wall situated between the metal plate and the metal plane.

12. An electronic device, comprising:
a metal frame; and
a slot dipole antenna covered by the metal frame, wherein an image current on the metal frame is in-phase with a current of the slot dipole antenna.

13. The electronic device of claim 12, wherein the slot dipole antenna comprises:
a first ground surface coplanar to a metal plate to produce a first band resonance; and
a lump capacitor coupled to the first ground surface and to the metal plate.

14. The electronic device of claim 13, wherein the slot dipole antenna further comprises:
a second ground surface coplanar to the metal plate to produce a second band resonance; and
an inductor coupled between the second ground surface and the metal plate.

15. The electronic device of claim 12, wherein the slot dipole antenna comprises:
a ground surface coplanar to a metal plate; and
a circuit to adjust a resonance of the slot dipole antenna, wherein the circuit is connected to the ground surface and to the metal plate.
